(19) United States
(12) Patent Application Publication
(10) Pub. No.: US 2015/0142717 A1
(43) Pub. Date: May 21, 2015

(54) PROVIDING REASONS FOR CLASSIFICATION PREDICTIONS AND SUGGESTIONS

(71) Applicant: Microsoft Corporation, Redmond, CA (US)

(72) Inventors: John Guiver, Cambridge (GB); John Winn, Cambridge (GB); James Edelen, Kirkland, WA (US); Tore Sundelin, Redmond, WA (US)

(73) Assignee: Microsoft Corporation, Redmond, WA (US)

(21) Appl. No.: 14/084,554

(22) Filed: Nov. 19, 2013

(51) Int. Cl. G06N 5/02

(52) U.S. Cl. CPC G06N 5/022
USPC 706/46

(57) ABSTRACT

Technologies are generally provided for a prediction system to provide reasons corresponding to suggested classifications. The prediction system may predict classifications such as user actions on incoming messages to help users triage email, and may provide one or more reasons for classifications to a user. The prediction system may identify features of the message in order to make predictions about user interactions and to suggest an action to the user, where features may include characteristics of the email message such as sender identity. Presented reasons for a suggested action may convey observed features of the message that significantly contributed to the prediction decision, and were relatively unexpected compared to a typical item for a particular user.

### BACKGROUND

In a collaborative environment, users may receive vast amounts of data from a number of data sources such as content generators, databases, search engines, other users, and so on. For example, users may receive phone calls, email messages, calendar requests, text messages, and other types of data and alerts. Manually reading, responding, and organizing these vast amounts of data can be overwhelming, time-consuming, and inefficient for the individual users.

Some applications attempt to simplify user actions in response to the data by anticipating the actions the user may take upon receipt of the incoming communication. Such applications may attempt to understand the behaviors of the user by classifying the user's behavior based on observed user response trends. The applications may also provide suggested classifications (e.g., actions to take) to the user based on the observed behavior. However, some suggested classifications may seem generic, broad, or vague to a user, and the user may not be confident that the system has accurately predicted how the user may respond to the incoming communication.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a prediction system to provide reasons corresponding to suggested classifications. The prediction system may predict classifications (e.g., actions to take, message type, message urgency, etc.) on incoming messages to help users triage email, and may provide one or more reasons for suggested classifications to a user to help users to understand why the system made the prediction. The prediction system may identify features of the message in order to make predictions about classifications and/or user interactions and to suggest a classification to the user, and may map the features to reasons. A relative contribution score for each feature of the message may be calculated, and a list of reasons corresponding to the features may be presented to the user in a descending order of relative contribution.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example cloud-based environment for predicting classifications and providing reasons for predicted classifications;

FIG. 2 illustrates a top level schematic of a system that provides reasons corresponding to a suggested classification;

FIG. 3 illustrates a schematic of a system that provides a list of reasons corresponding to a predicted classification;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of providing reasons corresponding to a suggested classification of a prediction application, according to embodiments.

### DETAILED DESCRIPTION

As briefly described above, a system is provided to a prediction system to provide reasons corresponding to suggested classifications. The prediction system may predict classifications such as user actions on incoming messages to help users triage email, and may provide one or more reasons for suggested classifications to a user to help users to understand why the system made the prediction. The prediction system may identify features of the message in order to make predictions about classifications and to suggest a classification to the user, and may map the features to reasons. Presented reasons for a suggested classification may convey observed features of the message that significantly contributed to the prediction decision, and were relatively unexpected compared to a typical item for a particular user. A relative contribution score for each feature of the message may be calculated, and a list of reasons corresponding to each features may be presented to the user in a descending order of relative contribution.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for providing reasons corresponding to suggested classifications of a prediction system. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

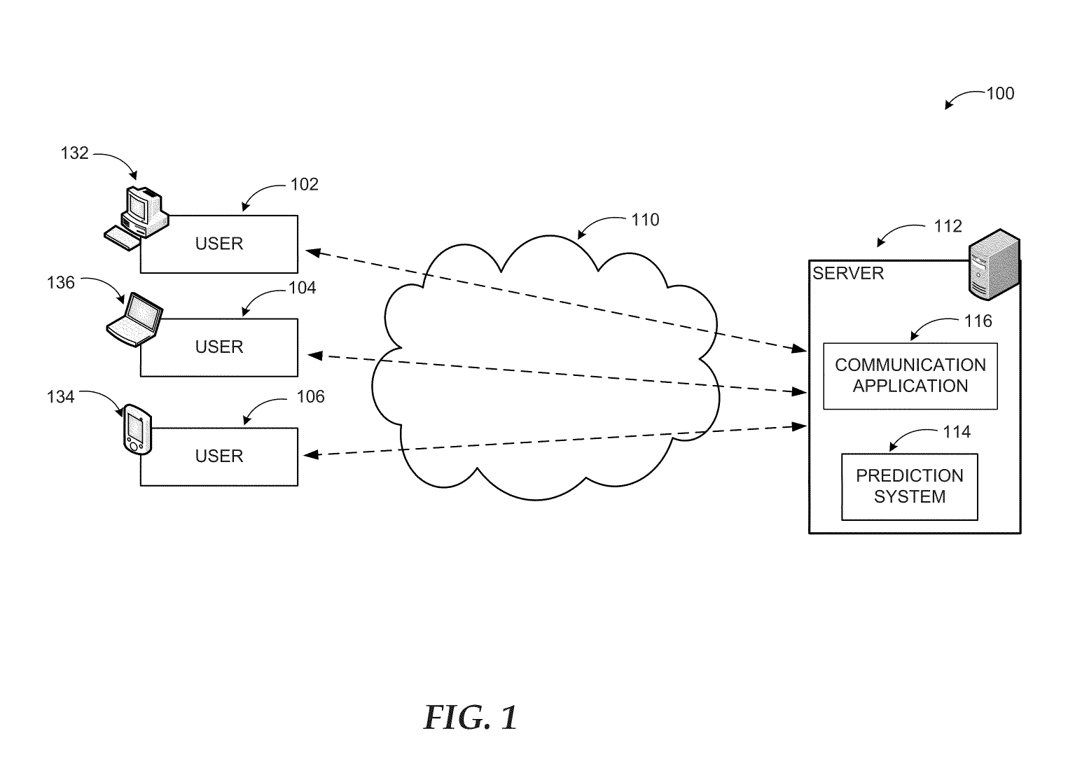

FIG. 1 illustrates an example cloud-based environment for predicting classifications and providing reasons for predicted classifications, according to embodiments.

As demonstrated in diagram 100, users (102, 104, and 106) may access an application providing a multitude of communication capabilities, such as a communication application 116, over a cloud-based network 110. The communication application 116 may be hosted at a remote server 112, and may be accessed through a user's client device over the cloud-based network 110. The communication application 116 may also be locally hosted at the user's client device, and data associated with the communication application may be retrieved from the remote server 112 over the cloud-based network 110. The communication application 116 may be an application providing a multitude of communication capabilities such as email, text messaging, VOIP, conferencing, instant messaging, phone calls, contacts, management, calendar management, and other similar capabilities. Different types of data associated with the communication application 116 such as email messages, text messages, instant messages, voicemail messages, phone calls, meeting requests, multimedia and/or audiovisual messages, documents, RSS feeds, social network updates, and other similar alerts and data may be received and interacted with at the user's client device. Example client devices may include a laptop computer 136, a desktop computer 132, a smart phone 134, a car phone, a mobile phone, a tablet, and/or a home automation device.

In an example embodiment, upon receipt of incoming communication over the cloud-based network 110 at the user's individual computing device, a user 102 may respond to the incoming communication by executing a particular action. For example, in response to receipt of an email message, the user 102 may read and respond to the email, ignore the email, prioritize the email, delete the email, flag the email, move the email to a particular categorized folder, and/or save the email for later, as some example user actions. Other classification examples may include, but are not limited to, a message type (e.g., newsletter, social network update, invoice, etc.), a message urgency, a message importance, a folder to file the message to, and so on. As another example, if the user 102 receives a calendar alert and/or an event request, the user may add the event to the user's personal calendar, and also may categorize the event as a work or personal event, and may mark the event as important. As yet another example, when the user receives a text message, some available response actions the user may take may include reading, responding, deleting, or saving the message for later. The above example response actions represent some available actions the user may take in response to incoming communication, however, it is recognized that there are multiple other actions that may be available for a user to take in response to receipt of varying incoming communication. Similarly, another user 104 associated with the communication application 116 over the cloud-based network 110 may receive personal data at the user's client device and may execute other actions in response to the received data.

In a system according to embodiments, a prediction system 114 associated with the communication application 116 may facilitate personalized classification and prediction of user interactions and/or classifications. Personalization may refer to learning about habits and characteristics of a user, and adapting a user's experience based on that learning. The prediction system 114 may observe multiple user interactions with data, and may predict classifications such as future user actions in response to the incoming communication based on the observed user interactions. Based on the predicted classifications, the prediction system 114 may be configured to provide a suggested classification to the user 102 in real time, and await user approval of a predicted action, for example. In another embodiment, the prediction system 114 may automatically perform the predicted action on behalf of the user 102. For example, the system may automatically save an email attachment to a predicted folder or mark an incoming message as high priority for response. The suggested classifications may be based on observations of multiple users concurrently, and in other embodiments, the suggested classifications may be highly personalized based on a particular user's observed interactions.

As described herein, an example prediction system 114 may be an email prediction system where the system may predict classifications such as reply, read, delete, forward, mark for follow up, ignore, and other similar actions on a received message to help users triage email by making personalized suggestions or indications based on model predictions. A user may desire to understand why the prediction system may suggest a particular classification to the user in order to feel confident that the suggested classification is associated with the most appropriate action for the user to take in a particular scenario. In a system according to embodiments, the prediction system may provide one or more reasons to the user when the system suggests a classification, where the reasons may describe why a particular suggestion or prediction was made by the system.

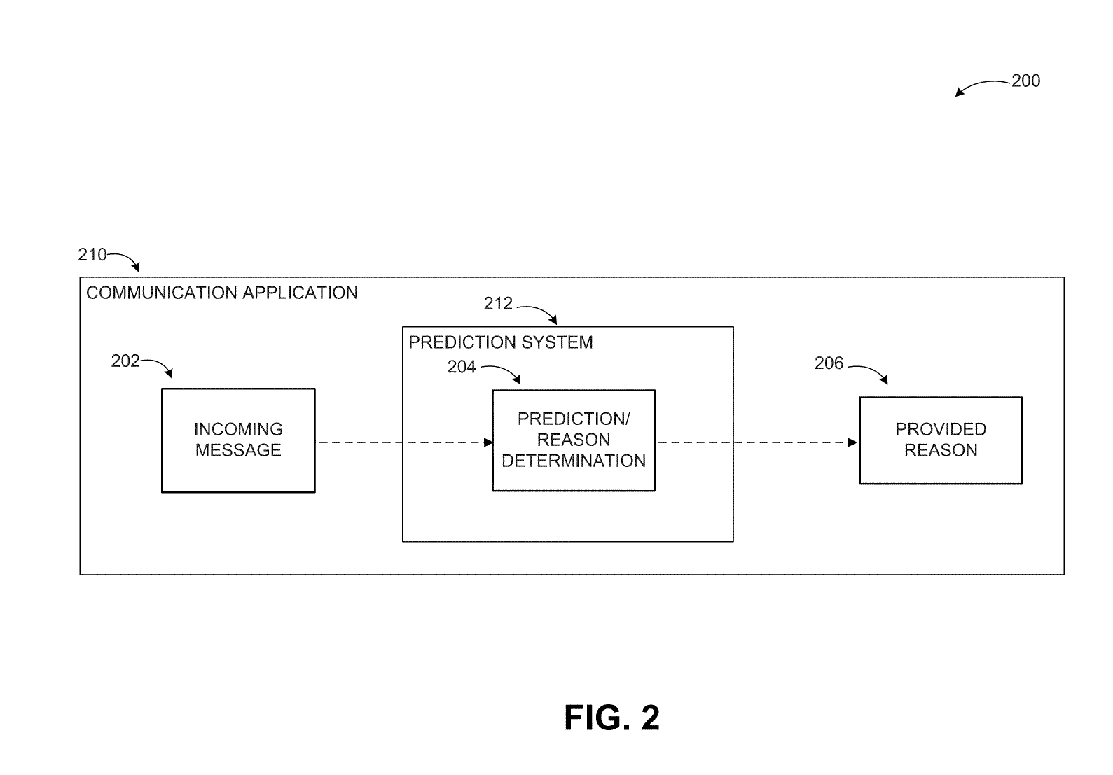

FIG. 2 illustrates a top level schematic of a system that provides reasons corresponding to a suggested classification, according to some embodiments.

As illustrated in diagram 200, a user may receive incoming communication, such as an email message 202, meeting request, event request, calendar alert, or other similar data, at a communication application 210 executed on the user's client device. A prediction system 212, as described previously, may predict and suggest classifications to a user based on observed features of the incoming communication.

In an example embodiment, when an incoming communication, such as an email message 202 is received, the prediction system 212 may identify features of the email message 202 in order to make predictions about classifications and to suggest an action or context of the message to the user. Features may include a number of characteristics of the email message 202, such as a sender identity, identified key words in a subject line or main body, an attachment, a red flag, a meeting request, and other similar characteristics. The prediction system 212 may suggest a classification based on the observed features of the email message, may determine reasons 204 for the suggested classification, and may provide 206 the reasons to the user for why the system suggested the classification. The reasons 204 for making a suggestion may be related to the observed features of the email message.

In a system according to embodiments, the reasons 204 provided to the user for a prediction or suggested classification may convey aspects of the item (e.g. the email message 202) that significantly contributed to the suggested classification, and features or characteristics of the email message 202 that may be relatively unexpected compared to a typical item specific to the receiving user. For example, an incoming message as an ordinary email message, compared to a meeting request, may contribute significantly to a decision to predict that the user will reply to the item. Since most messages that the user receives may be ordinary email messages that the user may often reply to, it may not be useful to highlight this as a reason to the user. However, if an incoming message is from a particular sender that the user often replies to, then the system may provide the reason with the prediction, since the observed sender identity makes a significant contribution and may be unexpected (i.e. since most emails are not from any one particular sender).

The unexpectedness of a feature may be determined for general users and also may be personalized for a particular user, such that a feature related reason may be weighted based on the user identity. Personalized determinations of unexpectedness may provide an enhanced experience for a particular user since some features of an email message may be more common for some users than other users. For example, an email message sent from a CEO or high level manager may invoke a rapid response from an average employee, and the system may weigh the CEO as the sender feature as a top reason for suggesting a reply action based on an unexpectedness of receiving an email from the CEO or manager. It may be common, however, for the CEO's (or manager's) assistant to receive multiple emails from the CEO, and the CEO as the sender feature may not be unexpected. A suggested rapid reply classification for the assistant may depend on other features of the email message, since the identity of the sender is not an unexpected feature for that user.

In an example embodiment, a multitude of feature related reasons may be predefined in the prediction system 212. Feature related reasons may vary based on each observed feature and classifications associated with observed features. Feature related reasons may be customized by an administrator and by individual users of the system to create a more personalized prediction system 212. Some non-limiting example reasons may include: the receiving user started this conversation, the receiving user is the only person on the To line, the receiving user previously contributed to this conversation, the sender marked the message high importance, the sender marked the message low importance, the sender is in your management chain, the sender is the receiving user's manager, the sender reports directly to the receiving user, the receiving user usually responds to/ignores/deletes messages from this sender, the receiving user's name is on the Cc line, the receiving user's name is on the To line, the message includes an associated calendar date, the receiving user received this as part of a distribution list, the receiving user's manager also received this mail, this is a reply to a message the receiving user sent, there are flagged messages in this conversation, one or more defined key words are identified in in the body, one or more defined key words are identified in the subject line, and other similar reasons. The above listed reasons are exemplary of some feature related reasons that may contribute to a suggested classification. The above listed reasons are not meant to be limiting, and many additional reasons may be defined by the system, administrator, other users, and may contribute to suggested classifications by a prediction system 212.

A reason for a suggested classification may include multiple parts based on two or more observed features. For example, the system may predict that the user will reply to an email message based on the sender identity and an identity of a user in the cc line of the email message. Additionally, multiple underlying features of the message may jointly contribute to the same reason. For example, the sender identity, whether the sender is the user's manager, and when the user last sent a reply to the sender may all contribute to the same reason for a suggested reply action.

In a system according to embodiments, the reasons for a suggested classification may be provided 206 to the user along with the suggested classification on a user interface of the user's client device. The system may provide 206 a top reason that contributed most to the suggested classification, or in other embodiments, the system may provide 206 a list of two or more reasons that contributed to the suggested classification. The list of reasons may be automatically displayed in a pop-up pane along with the suggested reason, or in another embodiment, the list of reasons may be a separately displayed item. The user may select to automatically display the reasons when a classification is suggested. Additionally, the suggested classification may display a selectable option to enable the user to select to display a reason when the user desires. Furthermore, a reason may be selectable to provide additional details about the reason, and what features and logic contributed to the suggested classification.

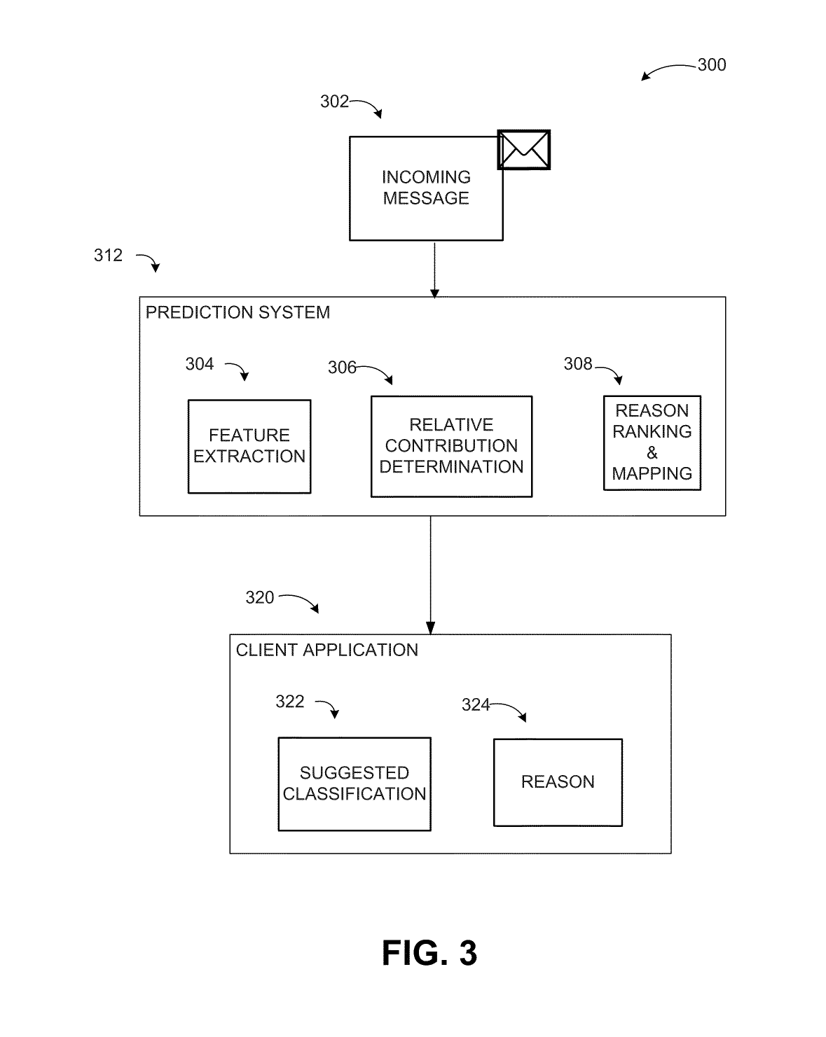

FIG. 3 illustrates a schematic for a system for providing a list of reasons corresponding to a predicted classification, according to some embodiments.

As illustrated in diagram 300, a prediction system 312 may predict and suggest classifications to a user based on observed features of incoming communication. In order to enable a user to feel confident that a suggested classification is an appropriate classification, the prediction system 312 may provide one or more reasons to the user to describe why a particular suggestion or prediction was made by the system.

In general, the prediction system 312 may predict a personalized probability of the user performing a particular action on a particular incoming message 302 at a prediction model, according to a defined prediction formula, for example P(prediction|item). The prediction system may extract 304 one or more features associated with the incoming message, such as a sender identity, or whether the receiving user initiated the communication, and may apply the prediction formula to the extracted 304 features. The prediction formula may use weighted features and values to represent an Absolute Contribution, where the Absolute Contribution may be a weighted sum of feature values to determine the Absolute Contribution of the feature to the prediction. In order to provide a reason for the contribution, the prediction system 312 may need to convert the Absolute Contribution to a relative contribution that takes into account background contributions to a particular observed features. Additionally, the prediction system 312 may merge contribution from several features into one reason in order to provide a specific reason for a predicted classification.

In a system according to embodiments, as described above, a feature may be exposed as a reason for a predicted classification when the feature has a significant contribution to the predicted classification, and where the feature is determined to be relatively unexpected with respect to the particular receiving user. In order to determine when an observed feature has a significant contribution to the predicted classification, the prediction system 312 may compute a Relative Contribution 306 of an observed feature of a received message (or other incoming communication). The Relative Contribution may be determined by comparing the Absolute Contribution with an Expected Contribution. The Expected Contribution can be calculated from an observed relative frequency of buckets associated with a particular feature, where a bucket may represent a set of discrete values of that feature. In an example calculation, f₁, . . . , fₙ may be the average value of each bucket for a given feature across a data set, and x₁, . . . , xₙ may be the bucket values (most will be 0) for a given message. Then:

Absolute Contribution (AC)=Σ₁^{h}wᵢxᵢ;

Expected Contribution (EC)=Σ₁ⁿwᵢfᵢ; and

Relative Contribution 306=AC−EC.

Features may be ranked 308 according to the calculated Relative Contribution 306 value, and a higher number for the Relative Contribution 306 may indicate a stronger feature contribution. Additionally, if two or more features contribute to a common reason, the features may be merged by summing or combining in some other way prior to ranking, and the Relative Contribution 306 for each feature may be averaged together to determine the overall Relative Contribution value. After ranking (308) the features, and mapping the features to reasons, as described further below, a set of reasons may be presented to the user along with a suggested classification. The presented set of reasons may include a top reason, or may include multiple reasons where a contribution value exceeds a defined threshold value.

The Expected Contribution may represent an expectation of a features contribution, i.e. an average of an expected contribution of a features across n random messages as n tends to infinity. It is not necessary to compute exactly this quantity, as transformations of the Expected Contribution that maintain the ordering of features may be used instead. In some embodiments, the Expected Contribution may be calculated in a number of different ways.

An example calculation of a Relative Contribution 306 for a feature may be as follows:

| Feature | Active Feature Bucket(s) |
|---|---|
| . . . | |
| PreviousFlagged | 5 |
| RecipientOnToLine | John Doe, Jane Smith |
| . . . | |

The Relative Contribution 306 for all features of the message, including specifically PreviousFlagged and RecipientOnToLine, may be computed. The system may calculate the Relative Contribution 306 for all features, but for an illustrative example, the system may consider PreviousFlagged and RecipientOnToLine.

First a contribution score for each of the feature buckets for the PreviousFlagged feature may be computed, as illustrated in the following table:

| “PreviousFlagged” | Weighted | Average |
|---|---|---|
| Feature Bucket | Mean | Value |
| 0 | 1.01411879062653 | .55 |
| 1 | 1.59830498695374 | .10 |
| 2 | 1.76304030418396 | .08 |
| 3 | 1.15598356723785 | .07 |
| 4 | 1.88279759883881 | .06 |
| 5 | 1.80184161663055 | .06 |
| 6 | 2.57335090637207 | .04 |
| 8 | 1.85421621799469 | .04 |

The weighted mean is a predetermined value associated with each feature bucket to weight a contribution of the feature bucket to the feature. The “weighted mean” refers to a scaling factor on the “Average Value”. In the example, the scaling factor is the probability the feature is present in all items. Other types of scale factors may also be employed. The PreviousFlagged feature may be a particular type of feature where an Average Value for this type of feature may be the ratio of items where the feature is present to total items, such that the Average Values sum to 1)

Since the active feature bucket is 5, the system may take the weighted value of 1.80184161663055 for performing calculations. The Expected Contribution is 1.337739 based on the provided EC formula (Σ₁ⁿwᵢfᵢ), and the Absolute Contribution is 1.80184161663055*1=1.80184161663055. Thus the Relative Contribution 306 for the PreviousFlagged feature is 1.80184161663055−1.337739=0.464103.

A similar computation may be performed for the RecipientOnToLine feature.

| “RecipientOnToLine” | Weighted | Average |
|---|---|---|
| Feature Bucket | Mean | Value |
| . . . | | |
| Jane Smith | 1.81966972351074 | .03 |
| John Doe | 1.96343159675598 | .04 |
| . . . | | |

In this case, the EC may be 1.023782, the AC for John Doe may be 1.963431*0.5=0.981716, and the AC for Jane Smith may be 1.8196697*0.5=0.909835. The value of 0.5 may be used because there are two values (two recipients: John Doe and Jane Smith) for the RecipientOnToLine feature, so the value for each is evenly split across all active buckets for this feature, or ½. (or more generally 1/N). The total AC for each bucket may be =0.981716+0.909835=1.891551 and the Relative Contribution 306 for the RecipientOnToLine feature may be =1.891551−1.023782=0.867769.

In a system according to embodiments, after calculating the Relative Contribution 306 for each observed feature of an email message, the prediction system 312 may map one or more features and associated buckets to a reason. For example, the system may provide multiple potential reasons corresponding to the suggested classification, and may associate, or map, each feature to the reason that it contributes to. The following table demonstrates example mapping of features to reasons:

| | | Contribu- |
|---|---|---|
| | | tion |
| | | Aggrega- |
| Reason | Features/Buckets | tion |
| You started this | ConversationStarterIsYou: 1 | |
| conversation | | |
| You are the only person on | OnlyRecipient: 0 | |
| the To line | OnlyRecipient: 1 | |
| You previously contributed | ConversationContributions: >0 | |
| to the conversation | | |
| Sender marked the message | IsMarkedImportantBySender | |
| high importance | | |
| Your name is on the To line | RecipientPositionOnToLine: >0 | |
| Your name is on the Cc line | RecipentPositionOnCcLine: >0 | |
| Your manager also | ManagerPositition: 2 | |
| received this mail | ManagerPosition: 3 | |
| This is a reply to a message | ReplyToAMessageFromMe: 2 | |
| you sent | | |
| You previously flagged | PreviousFlagged: >3 | |
| messages in this | | |
| conversation | | |
| You often <action> to | RecipientsOnToLine | Average |
| messages that include these | RecipientsOnCcLine | |
| recipients | | |
| You often <action> to | SubjectWords | Average |
| messages with similar | BodyWords | |
| words | | |

A feature bucket in the “Features/Buckets” column may map to the reason in the “Reason” column. If there are multiple features in the “Features/Buckets” column, the “Contribution Aggregation” column may specify the function that will be used to compute the overall contribution score for that reason (e.g. Average).

In a system according to embodiments, after mapping the features to reasons, the mapped reasons may be sorted and filtered to determine what reasons 324 may be presented to the user at the user's client application 320. Reasons 324 that provide a significant contribution to a predicted classification may be presented to the user, and the remaining reasons may be filtered out of the list. There may be a defined threshold value for a contribution on the feature contribution score that sets which items to filter, such that only items above the threshold value may be considered to significantly contribute to a reason, in order to limit a number of reasons presented to the user. The threshold value may be run-time configurable. The system may have a maximum number of reasons 324 that may be reported to the user, where the maximum number of reported reasons may not exceed a number of supported reasons 324. Any number of reasons may be supported and considered by the prediction system 312 when determining a reason for a predicted classification. The reasons 324 may be displayed in a list of reasons presented to the user along with the suggested classification 322, and the reasons 324 may be sorted based on their contribution score, in descending order. In other embodiments, only a main reason having the highest contribution score may be presented to the user. The user may also customize a presentation of reasons based on user preferences.

In a further embodiment, a provided reason 324 associated with a received message (or other incoming communication) may be stored in metadata associated with the received message, or may be stored as part of a message object of the received message. For example, a particular reason may be assigned an identifier, and the identifier may be stored in the message object of the received message, such that as the message is moved, forwarded, saved, or otherwise interacted with, a particular classification and associated reason may be persisted. Additionally, the identifier may be mapped to a string such that any client may be able to localize the value in any language supported by the client.

The example applications, devices, and modules, depicted in FIGS. 1-3 are provided for illustration purposes only. Embodiments are not limited to the configurations and content shown in the example diagrams, and may be implemented using other engines, client applications, service providers, and modules employing the principles described herein

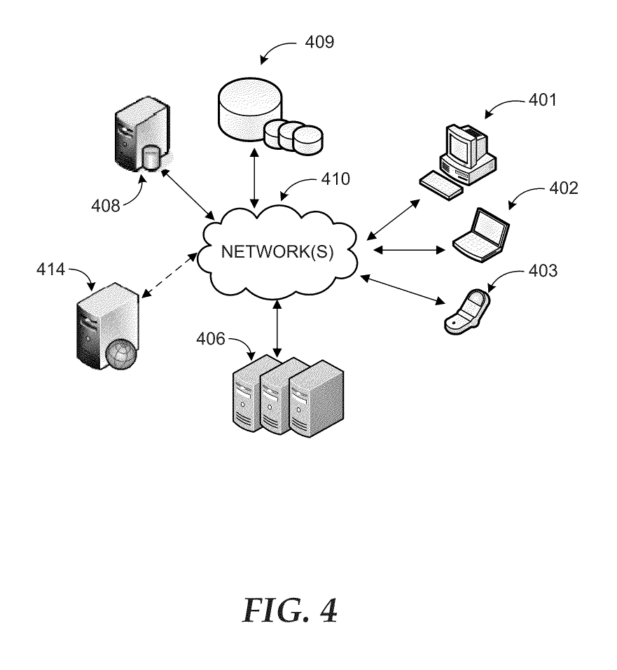

FIG. 4 is an example networked environment, where embodiments may be implemented. In addition to locally installed applications, a prediction application providing reasons associated with suggested classifications may also be employed in conjunction with hosted applications and services that may be implemented via software executed over one or more servers 406 or individual server 414. A hosted service or application may communicate with client applications on individual computing devices such as a handheld computer, a desktop computer 401, a laptop computer 402, a smart phone 403, a tablet computer (or slate), (‘client devices’) through network(s) 410 and control a user interface presented to users.

Client devices 401-403 may be used to access the functionality provided by the hosted service or application. One or more of the servers 406 or server 414 may be used to provide a variety of services as discussed above. Relevant data may be stored in one or more data stores (e.g. data store 409), which may be managed by any one of the servers 406 or by database server 408.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a behavior prediction and classification system with user feedback on reasons for the predictions. Furthermore, the networked environments discussed in FIG. 4 are for illustration purposes only. Embodiments are not limited to the example applications, modules, or processes.

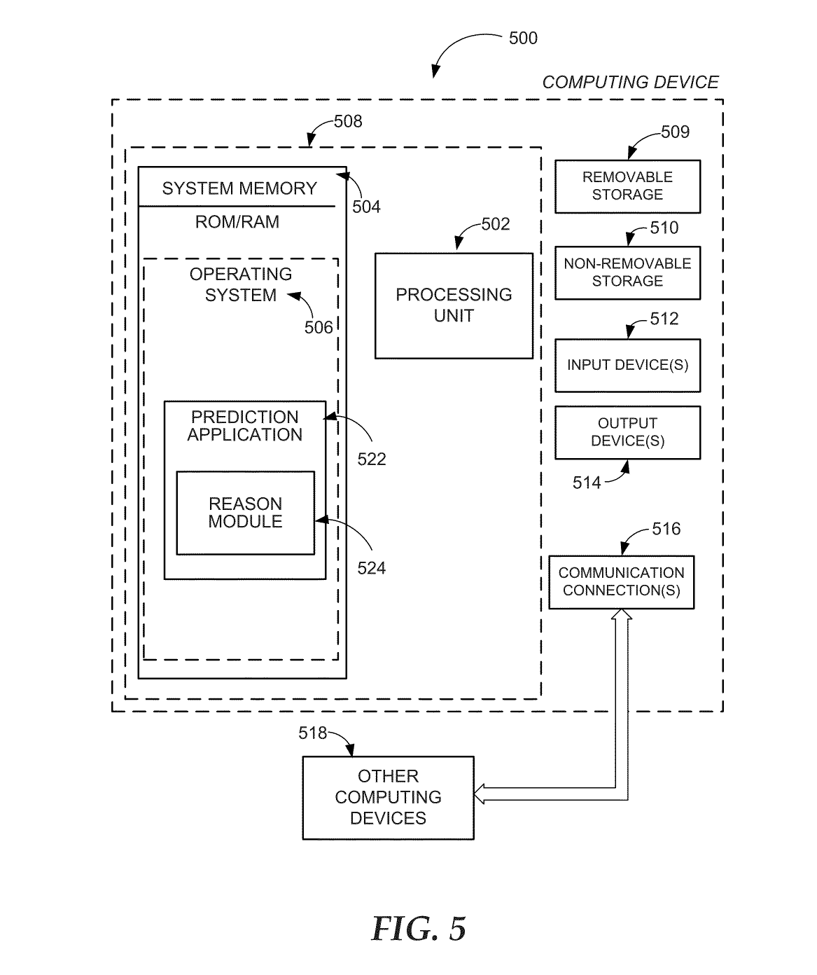

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any of the example devices discussed herein, and may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as prediction application 522 and reason module 524.

The reason module 524 may operate in conjunction with the operating system 506 or prediction application 522 to observe an incoming communication at a communication application associated with a user, and to identify a plurality of features associated with the incoming communication. The reason module 524, in conjunction with the prediction application 522, may predict and suggest classifications in real time based on the identified features of the incoming communication, and may provide a set of reasons for the suggested classifications to the user along with the suggested classifications. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

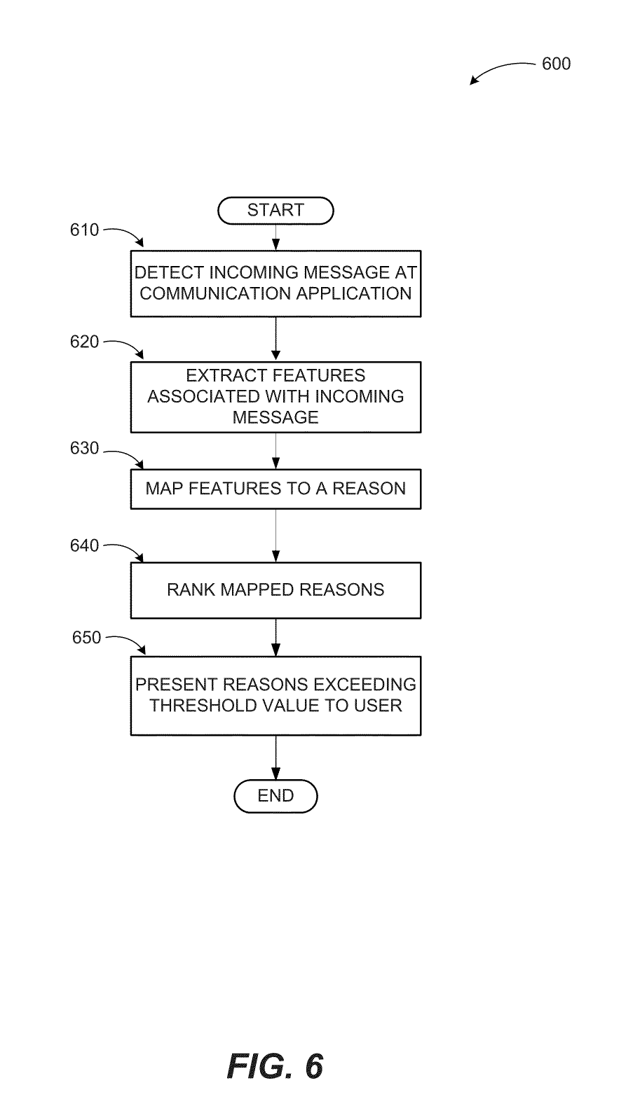

FIG. 6 illustrates a logic flow diagram for a process of providing reasons corresponding to a suggested classification of a prediction application, according to embodiments. Process 600 may be implemented as part of an application or an operating system.

Process 600 begins with operation 610, “DETECT INCOMING MESSAGE AT COMMUNICATION APPLICATION,” where a prediction system may detect an incoming message at a communication application. The prediction system may also detect other incoming communication such as an instant message, a meeting invite, an audio communication, a video communication, a data sharing invite, and an application sharing invite at the communication application.

Operation 610 is followed by operation 620, “EXTRACT ONE OR MORE FEATURES ASSOCIATED WITH INCOMING MESSAGE,” where the prediction system may extract one or more features of the incoming message, where the features may be characteristics of the incoming message including, but not limited to: a sender identity, identified key words in a subject line or main body, an attachment, a red flag, a meeting request, and other similar characteristics. The prediction system may be configured to suggest a classification based on the observed features of the message, and to provide reasons for why the system suggested the classification.

Operation 620 is followed by operation 630, “MAP FEATURES TO A REASON,” where the prediction system may identify a set of classifications, or buckets, associated with each feature of the incoming message, and may weight a likelihood of each classification to predict the classification. In order to provide reasons, the system may determine a relative contribution of each feature and bucket to the suggested classification, and may map a reason to each observed feature.

Operation 630 is followed by operation 640, “RANK THE MAPPED REASONS,” where the mapped reasons may be ranked based on a calculated relative contribution score. The relative contribution score may be calculated based on an absolute contribution and an expected contribution including predefined feature weights. The mapped reasons may be ranked based on the relative contribution score in a descending order.

Operation 640 is followed by operation 650, “PRESENT REASONS EXCEEDING THRESHOLD VALUE TO USER,” where a list of one or more reasons for a suggested classification may be presented to the user along with the suggested classification. A threshold value may be defined for a feature relative contribution score, and only features above the threshold value may be considered to significantly contribute to a reason. The presented list of reasons may include a top reason, or may include multiple reasons where the contribution score exceeds the defined threshold value.

The operations included in process 600 are for illustration purposes. Providing reasons corresponding to a suggested classification to increase user confidence of the suggested classification according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to provide reasons corresponding to a suggested classification of a prediction system, the method comprising:
receiving an incoming communication at a communication application;
predicting one or more classifications associated with the incoming communication;
determining one or more reasons for the predicted classification;
suggesting the predicted classification to a user; and
presenting the one or more reasons to the user along with the suggested classification.

2. The method of claim 1, further comprising:
extracting one or more features associated with the incoming communication.

3. The method of claim 2, wherein the one or more features include characteristics of the incoming communication including at least one from a set of: communication type, a sender identity, recipient identities, identified key words or topics in a subject line or main body, an attachment type, attachment content, one or more previous contributions to the communication thread, document, or attachment by the user, and a message flag.

4. The method of claim 3, wherein predicting the one or more classifications comprises:
determining an absolute contribution of each of the one or more features, wherein the absolute contribution is a weighted sum of feature values.

5. The method of claim 4, wherein determining the one or more reasons comprises:
determining when a feature substantially contributes to a reason and is relatively unexpected compared to ordinary incoming communications associated with the user.

6. The method of claim 5, further comprising:
determining a relative contribution of each of the one or more extracted features.

7. The method of claim 6, further comprising:
determining the relative contribution based on a comparison of an expected contribution and the absolute contribution, wherein the expected contribution is computed based on an observed frequency of buckets associated with the one or more features.

8. The method of claim 7, wherein the buckets represent a set of discrete choices associated with each feature of the incoming communication.

9. The method of claim 1, further comprising:
generating a list of reasons that contribute to the suggested classification; and
mapping each observed feature to one of the reasons to which it contributes.

10. The method of claim 9, further comprising:
ranking each reason based on a calculated relative contribution value; and
sorting the list of the reasons in a descending order of relative contribution values.

11. The method of claim 10, further comprising:
presenting the reasons to the user where the relative contribution values for the one or more features contributing to the reasons exceed a predefined threshold value.

12. A computing device to provide reasons corresponding to a suggested classification of a prediction system, the computing device comprising:
a memory;
a processor coupled to the memory, the processor executing a prediction application, wherein the processor is configured to:
receive an incoming communication at a communication application;
extract one or more features from the incoming communication;
predict one or more classifications associated with the incoming communication;
determine one or more reasons for the predicted classification;
suggest the predicted classification to a user; and
present the one or more reasons to the user along with the suggested classification.

13. The computing device of claim 12, wherein the communication application facilitates one or more of: an email exchange, an instant message exchange, a text message exchange, a social or gaming network invite, a social or gaming network update, a blog post, a forum post, a tweet, an audio communication, a video communication, an online meeting, data sharing, document sharing, and application sharing.

14. The computing device of claim 12, wherein the incoming communication is one or more an email, an instant message, a text message, a social or gaming network invite, a social or gaming network update, a blog post, a forum post, a tweet, an audio communication, a video communication, an online meeting communication, data sharing data, document sharing data, and application sharing data.

15. The computing device of claim 12, wherein the processor is further configured to:
determine an absolute contribution of each of the one or more features, wherein the absolute contribution is a weighted sum of feature values.

16. The computing device of claim 15, wherein the processor is configured to:
determine a relative contribution based on a comparison of an expected contribution and the absolute contribution, wherein the expected contribution is calculated based on an observed frequency of buckets associated with the one or more features.

17. The computing device of claim 15, wherein the processor is configured to:
merge two or more features together to contribute to a reason.

18. A computer-readable memory device with instructions stored thereon to provide reasons corresponding to a suggested classification of a prediction system, the instructions comprising:
receiving an incoming communication at a communication application;
extracting one or more features from the incoming communication;
predicting one or more classifications associated with the incoming communication;
determining one or more reasons for the predicted classification;
suggesting the predicted classification to a user; and
presenting the one or more reasons to the user along with the suggested classification, wherein the one or more reasons include when a feature substantially contributes to a reason and is relatively unexpected compared to ordinary incoming communications associated with the user.

19. The computer-readable memory device of claim 18, wherein the instructions further comprise:
determining an absolute contribution of each of the one or more features, wherein the absolute contribution is a weighted sum of feature values; and
determining a relative contribution based on a comparison of an expected contribution and the absolute contribution.

20. The computer-readable memory device of claim 19, wherein the instructions include:
mapping each observed feature to the reason to which it contributes;
ranking each reason based on the relative contribution value;
sorting the reasons in a descending order of relative contribution values; and
presenting a top reason having a highest relative contribution value to the user.
